(19) United States
(12) Patent Application Publication
(10) Pub. No.: US 2002/0064765 A1
(43) Pub. Date: May 30, 2002

(54) Method for accessing, developing and commercializing academic technology research

(76) Inventors: Hiroki Yoshihara, Yokohama-shi (JP); Manfred Ernst Wolff, Laguna Beach, CA (US)

Correspondence Address: Manfred E. Wolff, Intellepharm, Inc., 1304 Morningside Drive, Laguna Beach, CA, 92651, US

(21) Appl. No.: 09/910,557

(22) Filed: Jul. 20, 2001

Related U.S. Application Data
(60) Provisional application No. 60/219,870, filed on Jul. 20, 2000.

(51) Int. Cl. G09B 23/00

(52) U.S. Cl. 434/276

(57) ABSTRACT

A method for industrializing academic research technologies comprising methods to gain access to a broad array of important new molecular targets discovered by leading academic scientists, and to provide platform capabilities to systematically commercialize said drug target discoveries for producing new drugs for said targets.

### CROSS REFERENCE TO RELATED APPLICATIONS

This application claims the benefit of U.S. Provisional Application No. 60/219870 filed Jul. 20, 2000.

### BACKGROUND ART

The present invention is related to methods for industrializing academic research technologies. More specifically, this invention is related to methods to gain access to a broad array of important new molecular targets discovered by leading academic scientists, and to provide platform capabilities to systematically commercialize these drug target discoveries for producing new drugs for these targets. By these methods, the industrialization of academic technologies is broadly enabled, whereby the functional utility, ease of use, and wide applicability of the method in industrial drug discovery and development constitutes progress in science and the useful arts.

Drugs are chemicals that interact with a target molecule within the body, typically a protein, either to induce or to inhibit the molecule's normal functioning while producing as few unwanted side effects as possible. Drugs generally exert their effect by interacting with membrane receptors, enzymes, or ion channels—acting as “keys” fitting into appropriate “locks”. The more selective or specific a drug can be in its interaction at these sites—the better the key fits the lock—the more useful the drug becomes.

The research and development activities required to put new medicines into the marketplace require an enormous commitment of funds. When considered as a percentage of sales, the pharmaceutical industry has one of the highest R&D expenditures of any industry. Of every five compounds that reach IND (Investigational New Drug) status, only one eventually emerges as a marketed drug. A much larger number of (1,000 to 1,000,000) compounds must be synthesized and evaluated biologically to produce a single IND candidate. Thus, the failure rate in drug discovery is high, and the cost of discovering a new drug and bringing it to market is currently estimated at $359 million, considering the failure rate and costs of capital.

Although the magnitude of spending on industrial pharmaceutical R&D nearly quadrupled during the past decade, the number of new drug approvals in the US has hovered around 20, and has doubled only recently. Only 12 new chemical entities (NCE's) were approved in the US in 1998. It has been estimated that a shortfall of 30 of NCE's per year exists if the top 50 pharmaceutical companies are to maintain a 10% annual growth rate. In addition, the average cycle time from synthesis to approval nearly doubled from 8 years in the 1960's to 15 years in the 1990's. The longer cycle time poses a particular problem because of the effect of the General Agreement on Tariffs and Trademarks (GATT), which sets a patent life of 20 years from the date of filling. The useful patent life of an approved new chemical entity is thus likely to be reduced to only an average of 5 years (although partial term restoration is possible in some, but not all, countries). In addition to the preceding factors, healthcare is being subjected increasingly to cost containment. All of the environmental changes thus mandate a more efficient drug discovery process utilizing new enabling technologies.

Where can the pharmaceutical industry obtain new drug targets and/or lead compounds to fill its pipeline? The pharmaceutical industry has three primary sources of new drug targets and lead compounds.

Internal research and development (R&D)

Biotechnology industry

Research institutions such as federal laboratories and biomedical research universities

Each of these options for enhancing the new product pipeline of the pharmaceutical industry presents its own set of challenges:

### Increase Internal R&D Resources

It is obvious from the growth in research and development budgets that the pharmaceutical industry remains committed to pursuing internal R&D efforts. Bigger is not always better however, sometimes leading to bloated and ineffective bureaucracies with colossal fixed infrastructure costs.

### Biotechnology Industry

Most of the 1,300 biotechnology companies launched in the U. S. during the past 20 years have served as a source of novel products for the pharmaceutical industry. However, they have not been able to supply the pharmaceutical industry with enough new drug candidates to support its growth objectives.

The business models for most biotechnology companies assumed strategic collaborations with large pharmaceutical companies for development of specific products in defined therapeutic areas, such as oncology or infectious diseases. The biotechnology companies relied on funding from these entities to enable them to develop their own drug portfolios while fulfilling their obligations to their collaborators.

This model has not worked particularly well. In some cases, the biotechnology companies envisioned themselves as “FIPCos” (Fully Integrated Pharmaceutical Companies) and established their own discovery/development and commercialization infrastructures. This enormous investment was difficult for a company with a single or limited technology to justify no matter how compelling their product or robust their “technology platform.” The financial constraints resulting from this approach, combined with the capital-intensive nature of the biotechnology business, forced many companies to concentrate on a single, high-risk project. Each such project shares the same high risk of failure typical of R&D programs in the pharmaceutical industry. Consequently, many start-ups failed, but not until they had exhausted significant resources and time to attempt success with a single potential product.

What has recently emerged from the experiences of the biotechnology industry's first 20 years are two key niches for biotechnology companies.

Generation of new disease-associated targets

Development of innovative discovery technologies such as functional genomics, combinatorial chemistry, and high-throughput screening (HTS) that accelerate the identification of novel disease-associated targets for drug discovery arid that optimize leads

Pharmaceutical companies have demonstrated a willingness to pay substantial sums for such technologies. All of these deals represent investment primarily in new, unvalidated targets for drug discovery—not true pharmaceutical lead compounds. Yet, the pharmaceutical industry has allocated substantial sums for such deals: Roche-DeCode Genetics/1998 ($200), Bayer-Millennium/1998 ($465 M), American Home Products-Millennium/1996 ($100 M), SmithKline Beecham-Human Genome Sciences/ 1993 ($125 M).

These collaborations have been successfully producing number of genetic targets that these pharmaceutical companies are using to fuel their drug discovery efforts. It is not, however, clear that these newly discovered targets will turn out to be most pharmacologically relevant targets. According to a recent Wall Street Journal article, Roche had more clinical trial failures and drug withdrawals between 1997and 2000 compared to any similar period ever. Cutting-edge science remains an essential part of Roche's research strategy. A gene-hunting collaboration with DeCode Genetics Inc. has uncovered novel genes believed to play important roles in illnesses ranging from schizophrenia to Alzheimer's disease. Recently Roche's scientists were prodded to concentrate exclusively on biological targets discovered by its biotech collaborators. But such novel targets lack sufficient target validation and were difficult to test. Confirmation of the targets often requires massive, expensive clinical trails. Targets were developed with only scant hints about the likely outcome until significant amounts of the money had been spent. If you choose the wrong target you will never make it to market, no matter how hard you work on it.

Because of their position at the frontier of creativity-driven discovery, researchers from university and federal laboratories have long represented an enticing potential source of new, validated, disease-associated targets and initial compound hits for the pharmaceutical industry. Although there have been some successful collaborations, for example, Taxol® (National Cancer Institute) for the treatment of breast cancer, and Zetit® (Yale University) for the treatment of AIDS —such collaborations have been remarkably limited, due in part to a fundamental culture clash.

The goal of biomedical research universities is to understand the molecular basis of human biology. The goal of pharmaceutical companies is to commercialize drugs. Pharmaceutical companies have found it difficult to mesh their corporate, profit-driven culture with the academic research culture, whose pursuit of knowledge typically has no product, application, or obvious monetary endpoint.

The sheer size and complexity of pharmaceutical research often overwhelms the typically tiny research laboratory from which major pharmaceutical companies license discoveries.

Collaborations between the industry and universities tend to focus on early, “gleam-in-the-eye” projects that pharmaceutical companies can incorporate into their established fields of scientific and commercial interest, rather than on direct drug discovery.

Regardless of how exciting, well funded, or promising their research programs may be, universities generally do not generate pharmaceutical lead compounds because they lack the discovery resources and expertise required to move fundamental discoveries along the product development pathway. Consequently, university discoveries tend to be early-stage pharmaceutical targets that are licensed for small sums of money relative to payments made for technologies generated by biotechnology companies. Variations on business methods for industrializing academic technologies have not been forthcoming, despite the stated need for taking advantage of this valuable source of technology. Even though licensing is used extensively in the pharmaceutical industry, prior methods available to industry have not adequately addressed the need for advanced methods for industrializing academic technologies as set forth below.

The present invention embraces and finally addresses the clear need for advanced methods for industrializing and developing academic research technology discoveries. Thus, as pioneers and innovators attempt to make methods for industrializing and developing academic research technology discoveries more universally used, none has approached this challenge in a truly purposeful, reliable, and cost efficient manner until the teachings of the present invention. It is respectfully submitted that other references merely define the state of the art or show the type of systems that have been used to alternately address those issues ameliorated by the teachings of the present invention. Accordingly, further discussions of these references has been omitted at this time due to the fact that they are readily distinguishable from the instant teachings to one of skill in the art.

### OBJECTS AND SUMMARY OF THE INVENTION

Accordingly, it is an object of the present invention to provide new products, which are the scarcest commodity in the pharmaceutical industry. Another object of the present invention is to aid in building a strong and viable product pipeline, which not only positions a company for commercial success, but also positions the company to survive the merger wars that are sweeping the industry.

Still another object is to provide access to the state of the art research being conducted at university and national laboratories in the U. S. and possibly in Europe and Japan. Yet still another object of the present invention is to obtain technology in a highly cost effective manner. Licensing university stage research is very cost effective. Often the technology is the result of years of effort funded by the government and philanthropic organizations in direct investment and additional indirect investments (equipment, space, facilities to complete the research). At maturity, these technologies can be licensed for considerably less than the investment made in the technology. Even a further object of the present invention is to stay abreast of changing technologies in the drug discovery sector. The rate of change of technology is now incredibly high. New product and technology can become obsolete in a matter of months. Changes in technology and peoples use of technology are some of the more significant risk factors that a company's management face today. Failure to keep up with technology can doom a company to failure; adapting to the wrong technology can also be equally damaging. The method of this invention can supply pharmaceutical companies with a technology and product stream for insulation from the changes in the technology in core business areas. Even still a further object of the present invention is to provide three of the rarest commodities in business—products, enabling technologies and knowledge (information) base for strategic and tactical research management alternatives. Thus, the method generates a series of tangible drug discovery and development seeds with the first negotiation/refusal rights. They include validated druggable molecular targets, lead compounds for further chemical development (lead optimization), and development candidates. The method provides continuous access to emerging technologies which allow pharmaceutical partners to remain competitive in the rapidly paced innovations of drug discovery research. These include following drug discovery technologies: functional genomics and proteomics, cellomics, disease models, structural genomics, molecular function and protein folding analysis, computational chemistry and structure-based drug discovery, combinatorial and parallel synthesis chemistry, high speed medicinal chemistry, bioinformatics, chemoinformatics, pharmacoinformatics, chemical genomics and proteomics, functional chemical libraries (Evolutionary Libraries, Thermodynamic Controlled Libraries, and Retrosynthetic Libraries).

These and other objects are accomplished by the parts, constructions, arrangements, combinations and subcombinations comprising the present invention, the nature of which is set forth in the following general statement, and preferred embodiments of which—illustrative of the best modes in which applicant has contemplated applying the principles—are set forth in the following description and illustrated in the accompanying drawings, and are particularly and distinctly pointed out and set forth in the appended claims forming a part hereof.

The method of the invention uses a well-orchestrated multi-phase approach. Briefly, In Phase A, a number of sponsored research agreements and joint ventures are formed with university technology groups to enable the functions of target identification, target validation, and target selection of identified target technologies. A joint venture with platform technology companies is also formed to accelerate target validation and to initiate the drug discovery process for the validated targets early on. In Phase B, the method, through a joint venture with biotech companies, will develop new drugs for the validated targets identified through sponsored research agreements and joint ventures with universities using drug discovery and drug development technologies. In Phase C, rights to the resulting new patented pharmaceutical products that address large, unmet medical needs and have the potential for large profit margins are out-licensed to pharma companies. Revenues are derived from the resulting license fees.

More specifically, Phase A comprises target identification, validation, and selection. In Phase A, the method involves first systematically evaluating university molecular target technologies relevant to pharmaceutical research and development. Forty to fifty sponsored research agreements with leading universities are made over a three-year period. Additionally, for those opportunities that are broad enough, eight to ten joint ventures are formed with university technology groups to enable the functions of target identification, target validation, and target selection of identified target technologies.

In a typical arrangement, the method comprises selection of research fields from such categories as CNS, cardiovascular, kidney, liver, metabolic disease, inflammation, and oncology. The method will focus on the most desirable drug targets—targets that result in “category creator” drugs for entirely new applications for unmet medical needs. By contrast, the method will avoid the least desirable targets—those that lead to new versions of existing drugs. Rights are received to recombinant proteins and/or transfected cell lines relevant to the identified targets for future combinatorial chemistry and high throughput screening.

Phase B comprises lead identification and optimization. Through a joint venture with biotechnology companies, new drugs are developed for the identified targets using functional genomics, combinatorial chemistry, high throughput screening, pharmacology, medicinal chemistry, and ADME studies. As the target validation research projects mature and develop, a strategic joint venture with platform technology companies having functional genomics, proteomics, and medicinal chemistry capabilities, including diverse compound libraries and robust screening systems, is established. Phase C comprises patent protection and out-licensing. In Phase C, worldwide rights to commercial application of the assets—the targets, diagnostics, therapeutics, and nutraceuticals that address large, unmet medical needs and have the potential for large profit margins—are licensed to pharma and nutraceutical companies. Terms involve development license fees, milestones, and royalties on products.

### BRIEF EXPLANATION OF THE DRAWINGS

The foregoing and other objects and advantages of the invention will be appreciated more fully from the following further description thereof, with reference to the accompanying drawings wherein:

FIG. 1 is a diagram of one aspect of the method of the invention showing the business model of a company called URAF.

FIG. 2 is a schedule of the information flow of one aspect of the method of the invention as used in a company called URAF.

FIG. 3 is a diagram of one aspect of the method of the invention showing the due diligence structure as used in a company called URAF.

FIG. 4 is a table comparing the technology access program of a company called URAF using one aspect of the method of the invention with prior art methods used by pharmaceutical companies, biotechnology companies, and venture capital (VC) companies.

### DETAILED DESCRIPTION OF THE PREFERRED EMBODIMENTS

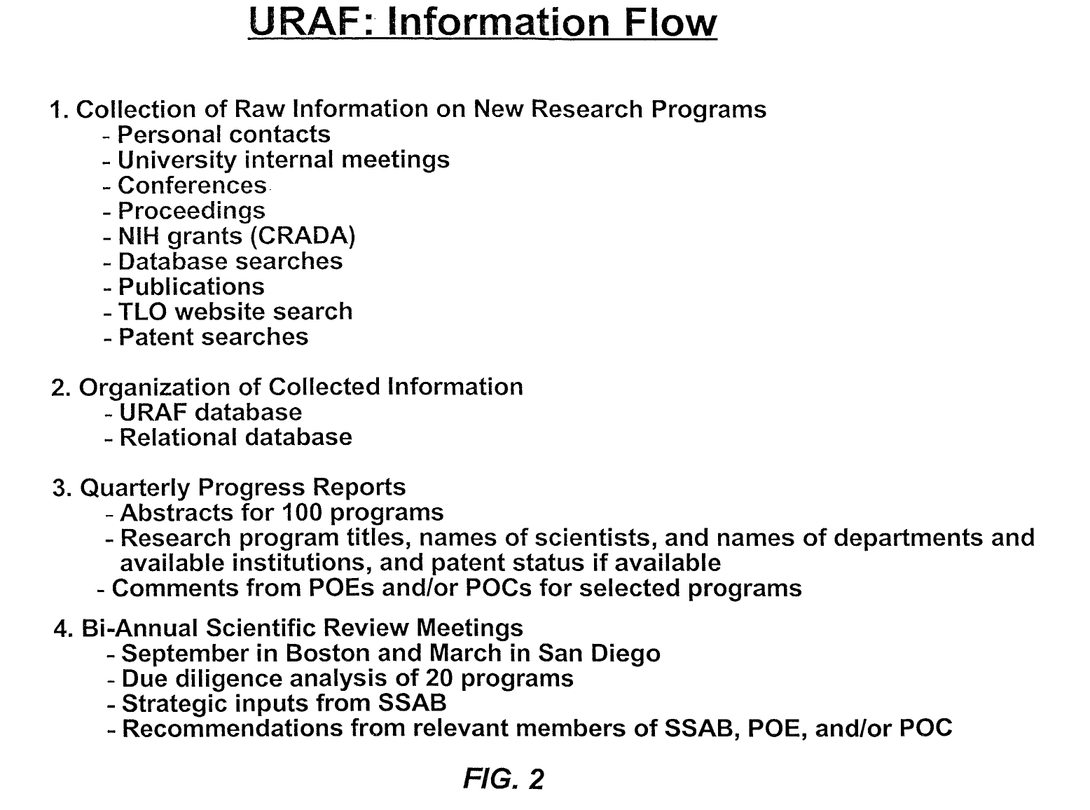

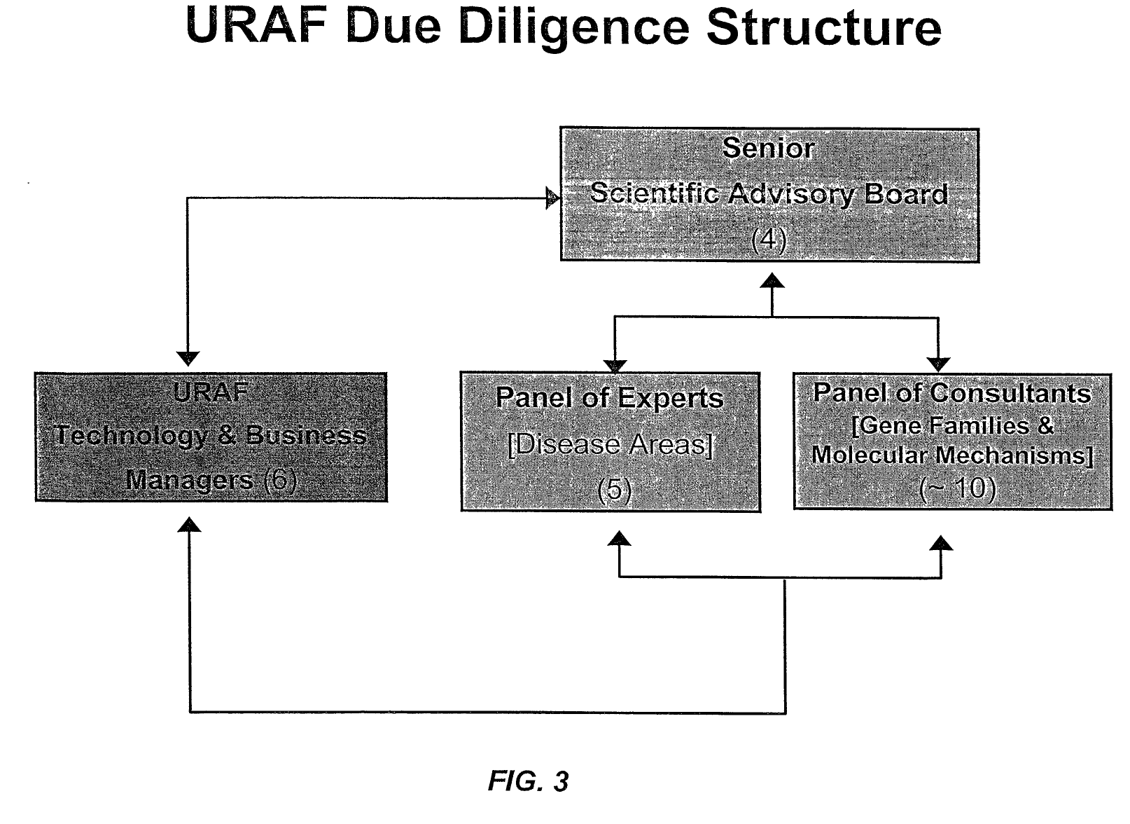

For Scientific Oversight purposes (FIGS. 2 and 3), the method includes the use of a Senior Scientific Advisory Board (SSAB) made up of outstanding scientists who can provide guidance to the scientific aspects of the programmatic activities. The SSAB will comprises individuals with outstanding credentials in the following areas: Biomedical Sciences, Drug Discovery, and Clinical Development.

Specialized scientific input will be obtained for the method from two sources in addition to the SSAB. One of the critical requirements we have in managing this effort successfully is; the availability of independent expert opinion in making our final decisions in project areas. The method therefore includes a Panel of Experts (POE) and a Panel of Consultants (POC) to insure that each project will get a complete detailed review. The POE comprises five experts in major disease areas including CNS), cardiovascular diseases, immunology, metabolic diseases, and cancer. The POC has expertise in a number of areas categorized by gene super-families and molecular mechanisms, such as proteases, kinases, phosphatases, GPCRs, ion channels, transcription and translation, apoptosis, chromatin remodeling and epigenesis, etc. The Panels work in concert with the SSAB which monitors the overall programmatic direction of URAF.

### Focus On Integrated Drug Discovery

Integrated Drug Discovery refers to the seamless and transparent integration of all of the Drug Discovery technologies using Discovery Teams. In an aspect of this method the integration will involve the university laboratories and the target-identification company(ies) through formation of a number of joint ventures. The elements comprising Integrated Drug Discovery are displayed below.

| TECHNOLOGY | TECHNOLOGY ELEMENTS |
|---|---|
| EARLY GENOMICS | SEQUENCING, POSITIONAL CLONING, |
| | MAPPING |
| FUNCTIONAL | GENE FUNCTION, SIGNAL TRANS- |
| GENOMICS | DUCTION, BIOINFORMATICS |
| PROTEOMICS AND | MEASUREMENT OF INDIVIDUAL PROTEIN |
| FUNCTIONAL | LEVELS AND DIFFERENTIAL DISPLAY |
| PROTEOMICS | PROTEOMICS |
| FUNCTIONAL | PHYSIOLOGICAL MODELS, PHARMA- |
| BIOLOGY | COLOGICAL MODELS, ASSAY |
| | DEVELOPMENT, BIOINFORMATICS |
| CHEMISTRY | COMBINATORIAL CHEMISTRY, CHEMICAL |
| | LIBRARY IDENTIFICATION, COMPUTER |
| | ASSISTED DRUG DISCOVERY, LEAD |
| | OPTIMIZATION, BIOINFORMATICS |
| SCREENING | HIGH-THROUGHPUT ASSAYS, |
| | BIOINFORMATICS |
| ADME | DRUG METABOLISM, PHARMA- |
| | COKINETICS, BIOINFORMATICS |

### Focus On Large And Unsatisfied Chronic Care Markets

In spite of significant progress in the last decade, there are still numerous large unsatisfied chronic care markets. As the population grows and ages, many of these areas are increasing in size: On the other hand, a number of these areas represent a difficult clinical trial and a difficult regulatory submission, because the endpoints are difficult to identify and quantify. Particularly difficult are Alzheimer disease and stroke endpoints. Clearer endpoints are available in the arthritis, osteoporosis, and antiviral areas. These clinical and regulatory questions are evaluated with the aid of the Clinical Development specialist(s) on the SAB.

| MARKET | DISEASES |
|---|---|
| CARDIOVASCULAR | CHF, ARRYTHMIAS, CORONARY ARTERY |
| | DISEASE, ACUTE MI, ISOHEMIC |
| | PERFUSION INJURY, REPERFUSION |
| | INJURY, CARDIAC AND VASCULAR |
| | HYPERTROPHY |
| ANTIINFECTIVE | MOST VIRUSES, MRSA, OTHER ANTI- |
| | BIOTIC RESISTANT STRAINS |
| CNS | ALZHEIMER DISEASE, STROKE, |
| | SCHIZOPHRENIA, MULTIPLE SCLEROSIS, |
| | MEMORY ENHANCEMENT |
| METABOLIC | TYPE II DIABETES, OSTEOPOROSIS |
| DISEASE | |
| RESPIRATORY | ASTHMA, EMPHYSEMA, CHRONIC |
| | OBSTRUCTIVE PULMONARY DISEASE |
| AUTOIMMUNE | RHEUMATOID ARTHRITIS, DIABETES, |
| | LUPUS |
| DERMATOLOGY | PSORIASIS, ACNE, ATOPIC DERMATITIS |
| ALLERGIC DISEASE | CONJUNCTIVITIS, RHINITIS, DERMATITIS |
| LIVER DISEASE | CIRRHOSIS, HEPATITIS C |
| KIDNEY DISEASE | DIABETIC NEPHROSIS |
| CANCER | MOST CANCERS |
| OTHER | OBESITY, ANTI-AGING |

### Focus On Category Creator Drugs

The method will focus on the most desirable drug targets—targets that result in “category creator” drugs for entirely new applications to unmet medical needs. By contrast, the method will avoid the least desirable targets—those that lead to new versions of existing drugs.

Categories of Innovation

| CATEGORY | CHARACTERISTICS |
|---|---|
| A | NEW CATEGORY. NO ALTERNATIVE TREAT- |
| | MENT AVAILABLE FOR ALL OR MOST PATIENTS. |
| | (EXAMPLE IS EPO) |
| B | NOVEL CLASS IN AN ESTABLISHED CATEGORY. |
| | SOME POTENTIAL TO EXPAND THE MARKET. |
| | (FIRST ACE INHIBITORS FOR HYPERTENSION |
| | AND CHF) |
| C | FAST FOLLOWER IN AN ESTABLISHED CLASS. |
| | PRODUCT MAY HAVE GOOD THERAPEUTIC |
| | BENEFITS AND HELP TO EXPAND THE MARKET. |
| | (ZANTAC) |
| D | “ME-TOO DRUG” LATER FOLLOWER IN AN |
| | ESTABLISHED CATEGORY OR CLASS, LIKELY |
| | TO REPLACE ITS PREDECESSOR RATHER THAN |
| | GENERATE NEW PATIENTS. (A NEW BETA- |
| | BLOCKER) |

### Systematic, Focused Evaluation of Opportunities

As already indicated, perhaps a thousand new drug targets will be discovered during the next few years. These targets will include G-protein coupled receptors, non-G-protein-coupled receptors such as the FGF receptor, enzymes, and ion channels. Today we have about 500 drug targets, approximately equally divided between G-coupled protein receptors and enzymes.

Thus, the setting of research priorities has been very much changed, and is driven by target selection rather than by lead identification. A major factor in this change is the emergence and commoditization of high throughput screening (HTS). HTS refers to the integration of technologies to rapidly assay thousands of compounds in search of biological activity for drug discovery. It is one of several tools pharmaceutical and biotechnology companies have to find leads for drug candidates.

HTS assays are designed around specific disease targets. Successful assay design, development, and validation are essential for the success of the HTS operation. Improvements and innovations in assay development include the development of technologies that allow multiple assays to be done simultaneously (multiplexing), that reduce the number of steps involved, that increase sensitivity, or that have increased biological relevance. Such advances in automation, assay types and development procedures, targets, detection modes, microplates, and microchips, have resulted in a growing industry to produce HTS equipment and supplies, and thus the commoditization of this recent technology. For example, PE Biosystems has recently announced its FMAT™8100 HTS System that uses fluorescent homogeneous assays for receptor-ligand, immunoassay, and cytotoxicity/apoptosis applications in a 96—or 384-well format and is available with application support. Thus, the latest innovations in HTS are widely and conveniently available, making the evaluation of alliance opportunities heavily dependent on target selection considerations.

### Target Selection Strategy

In general, the prioritization of research in the method requires a consideration and quantitation of a number of factors. The magnitude of each factor in a given research technology is determined, and the sum of the factors gives an overall score which used to rank the projects. The factors that are of particular importance in the method are the following:

1. The marketing interests of potential licensees. Are ophthalmologists, general practitioners, or cardiologists the targeted audience? This determines the disease categories of highest interest.

2. The magnitude of the market for the disease category—does the proposed therapeutic agent address a large unmet medical need? For example, a disease modifying antiarthritic is of greater interest than an antifungal. The novelty of the proposed approach: is the proposed therapeutic agent a category creator, an improvement on a known class, or a “me-too.”Another ACE inhibitor would not be of interest at this point, whereas an ANF sparing compound might well be of interest.

3. The R&D competition in the area of interest—an area that is already being explored by many other companies may not be a desirable choice.

4. The expertise of the partnering R&D staff—do they have expertise in the particular area in the target identification, target validation, and assay development sectors.

5. Probability of success—the strength of the hypothesis underlying the proposed therapeutic intervention, the state of the underlying science, and the resulting chance of success. With regard to the underlying science, the following question will be considered:

What targets are available that have the following attributes?

A. An identified target that has been validated in a cellular system or in a knockout animal

B. An assay system is in place suitable for high throughput screening

C. An indication that “drug-like” lead compounds (likely to be non-toxic and bioavailable, and capable of optimization) will be likely to have a desired effect on the target.

6. The patent situation of the proposed technology. Is the target proprietary and protected by patent filings?

7. The ease or difficulty of the anticipated clinical trial—for example, an Alzheimer drug may be faced with a difficult to measure endpoint.

8. The estimated timeline for the project—long or short?

### Evaluation of the Eight Elements

In the method, a scoring system is developed to assign a value of 1-10 for each of the eight elements. The sum of the scores is used to prioritize each opportunity.

### Phase A: Target Identification, Validation, and Selection

As previously stated, in Phase A, the objective of the method is to form a number of sponsored research agreements and joint ventures with research intensive universities to enable the functions of target identification, target validation, and target selection. Some of the joint venture alliances may take the form of equity participation in spin-off biotech startups newly established by faculty and universities.

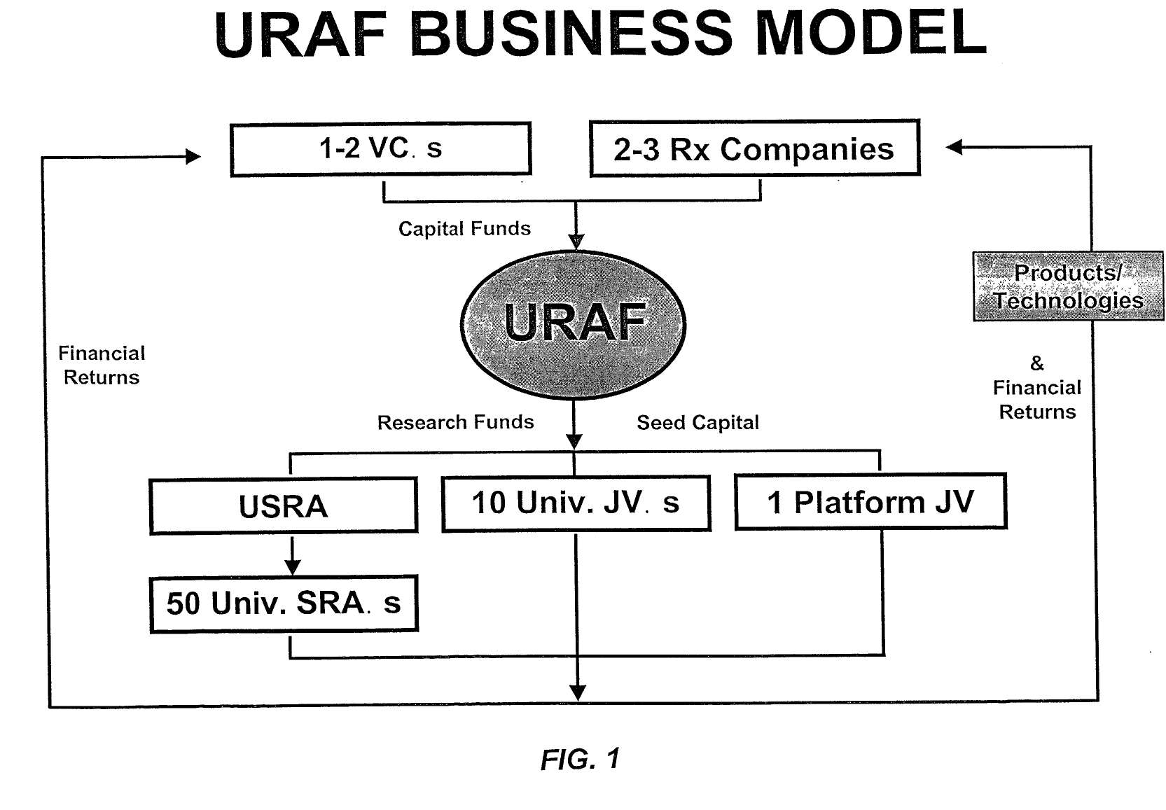

In a typical sponsored research agreement or joint venture , research fields from agents for cardiovascular, infectious, CNS, metabolic, respiratory, autoimmune, dermatologic, allergic, liver, kidney, neoplastic, and other pathologies are selected. A parent company, for example URAF (FIG. 1) will receive rights to recombinant proteins and/or transfected cell lines relevant to the identified targets for future combinatorial chemistry and high throughput screening. URAF will license the exclusive worldwide rights to commercial exploitation of the targets, diagnostics, and therapeutics derived from the research. Terms will presumably involve development license fees, milestones, and royalties on products. In addition, URAF will obtain patent protection for all identified technology. In the case of sponsored research agreements, URAF will receive an option to license the rights listed above as a part of the agreement.

### Sponsored Research Agreements (SRAs)

In using an aspect of the method, a company such as URAF will seek to form sponsored research agreements (SRAs) with research-intensive universities. This will be accomplished through monitoring of drug discovery in venues including scientific meetings and the scientific literature as well as through direct interactions with faculty and researchers. Research groups that are deemed to merit support by this process will be offered an SRA and an option for an exclusive license for technologies arising from the supported work is obtained.

Supported investigators will conduct research on target validation and assay development amenable to high throughput screening methods during the term of the Agreements. The goal will be to gain access to newly identified molecular targets for ultimate development.

In brief, a Technology and Business Team will identify and evaluate the plethora of new drug target opportunities that are available from research in research intensive universities and research institutes throughout North America and Europe. Using the criteria listed above, these opportunities will be prioritized using the paradigm already described. Based on the scientific strength, market considerations, and corporate fit, 40-50 of the most attractive of the target identification opportunities will be chosen for 2 to 3-year sponsored research agreements (FIG. 1)

### EXAMPLE 1 OF AN SRA

### Inhibitor of Catherpsin S As A Therapeutic

Foreign proteins internalized by cells are degraded into peptides. They are then displayed on the surface antigen presenting cells (APCs) by MHC class II molecules. It is only in this context that the CD4+ T cells of the immune system can recognize these foreign peptides. The peptide-binding site of MHC class II is blocked during assembly and intracellular transport by a chaperone transmembrane glycoprotein called the invariant chain (Ii). MHC class II —invariant chain complexes are delivered into the endocytic system, where the invariant chain is degraded by endosomal and lysosomal proteases, collectively known as cathepsins. A fragment of the invariant chain, CLIP (class II—associated invariant chain peptide), remains as a placeholder in the binding site until its dissociation is induced by interaction of the class II molecules with another class II-like molecule (H-2M in mice and HLA-DM in humans). Cathepsin S is the major li—degrading enzyme of B cells and dendritic cells (DCs), while cathepsin L is the major enzyme in cortical thymic epithelial cells. The unoccupied MFIC binding site then become available for peptide fragments from degraded foreign proteins. The class II—peptide complexes so generated are then transported to the cell surface.

Cathepsin S is a lysosomal cysteine protease of the papain family. Cathepsin S, but not cathepsin B, H, or D, is essential in B cells and DCs for effective invariant chain proteolysis necessary to render class II molecules competent for binding peptides. Cathepsin S inhibition has been shown to induce the accumulation of a partially proteolyzed fragment of the invariant chain in association with class II molecules and inhibits peptide loading. Cathepsin S is expressed largely in cells of mononuclear phagocytic lineage; this raises the possibility that cathepsin S is involved in macrophage-mediated tissue destruction.

The successful conclusion of in vivo efficacy proof-of-concept studies has been recently announced that confirmed the biological connection of cathepsin S to the inflammatory process. They successfully demonstrated in vivo efficacy of a selective cathepsin S. inhibitor in a model of asthma. The studies also showed that inhibiting cathepsin S could provide a directed way to regulate the pathological imbalances in autoimmunity and inflammation. Thus, drugs designed to inhibit this enzyme could provide a novel method for control of antigen-induced response in multiple inflammatory diseases such as asthma, COPD, atherosclerosis and a variety of autoimmune and inflammatory diseases.

### EXAMPLE 2: AN SRA WITH CONVERSION TO A JV

In the course of time, it may be desirable to convert particularly successful SRA's dealing with appropriately broad technologies into JV's as discussed in the next section. Such conversions will include equity participation in the JV by USRA and/or the Fund.

### Development Of Joint Ventures With Universities

An aspect of the method is formation of 8-10 strategic molecular target technology joint ventures in the case those opportunities are broad enough, some of which will be outgrowths of the 40-50 sponsored research agreements with research-intensive universities for ultimate out-licensing opportunities to pharmaceutical companies as shown in the diagram above. The goal will be to develop the newly identified targets in a revenue-producing manner. Based on the scientific strength, market considerations, and corporate fit, five to eight of the most attractive of the target identification opportunities will be chosen for joint ventures.

### JNK3 FOR STROKE & ALZHEIMER'S DISEASE AND OTHER TARGETS

The regulation of gene expression is a major new area of therapeutic intervention. The goal is to regulate the expression of the entire program of gene expression. The ability to repress programs of gene expression should have synergistic effects on preventing negative outcomes. In the case of stroke, several proteins (calpain, caspaces, etc) have been implicated in the loss of neurons. Successful treatment of stroke will require a inhibition of several proteins by modification of the gene expression program.

The understanding of the complex processes in stroke is an ongoing task. To date the stroke sequelae are roughly divided into two areas: the infarct region and the penumbral region. The infarct region is the area of the brain directly affected by the embolism leading to loss of blood flow and cell death. The penumbral region is the area that surrounds the infarct region, and is often much larger than the infarct region. Prevention of cell loss in the penumbral region should lead to a significant improvement in the outcome of stroke.

The activation of the gene program leading to cell death in the penumbral region in stroke is regulated by the MAP kinase JNK3. JNK3 is a member of the JNK family (JNK1, JNK2, JNK3) that regulate the c-jun. C-jun is a member of the leucine zipper family of transcription factors and heterodimerizes with fos to form the transcription factor AP-1. AP-1 regulates a number of gene families including the early response genes thought to play a role in neuronal cell death. JNK3 is in turn activated by the JNKK family of kinases.

JNK3 is found in high levels in the CNS. JNK3 is activated (phosphorylated) in the penumbral region of stroke. JNK3 is also found to be activated in dystrophic neurons in Alzheimer's Disease (AD). These neurites are thought to be processes from neurons that are in the process of dying.

JNK3 has been studied extensively. In the JNK3 knock-out mouse, JNK3 plays a critical role in stroke. Note that the JNK3 knockout is developmentally normal. The JNK3 knockout does not demonstrate neronal loss in the penumbral region of stroke. The c-dun is not activated, and early response genes are not expressed. Furthermore, cell death in the penumbral region is delayed by several hours, offering a window of opportunity for therapeutic intervention. Most current therapies require treatment to begin within 60 min of the ischemic event to offer any hope of response.

### Research Outline

The project has four phases:

1. Development of activated recombinant JNK3

2. Development of a HTS for JNK3

3. Screening for inhibitors

4. Test in animal models

Activated JNK3: Recombinant JNK3 can be easily produced in a number of systems—including yeast and bacculovirus. However, JNK3 must be activated by JNKK (serine kinase). Activation of the closely related JNK2 requires co-expression of JNK2 and an active JNKK mutant in bacculovirus. A similar procedure should work for JNK3.

HTS Assay: JNK3 phiosphorylates the N-terminus of c-jun. The 42 N-termianl amino acids of c-jun (junN42) have been used to develop an HTS assay for JNK2. JNK3 phosphorylates the same site as JNK2. A similar approach can be used to develop a HIS assay for JNK3 and junN42.

Screening: The HTS assay can be used to screen for inhibitors. General kinase assays will also be developed to screen for selectivity and specificity.

Animal Models: A number of standard animal models exist for stroke. The four vessel occlusion (4VO) model will be used to test compounds. The 4 VO model is the gold standard model for stroke. A dose response curve for each compound will be developed. Once the optimal dose is determined, a time course for each compound will be determined.

The expected results are a series of compounds that show anti-stroke activity and demonstrate activity when given several hours after the stroke. These data will be used to generate a JV for further development of the compound.

### CRADA

An aspect of the method contemplates an aggressive approach to accessing the work of more than 1,000 PhD and MD scientists working in more than 50 laboratories associated with the National Institutes of Health by means of the CRADA program as the part of its efforts. A CRADA, or a Cooperative Research and Development Agreement, is a formal research agreement between the National Institutes of Health (NIH) and a private sector company. CRADA was authorized under the Federal Technology Transfer Act of 1986 and was designed to foster collaborative research between federal agencies and private industry so that federally developed technologies could be turned into commercially viable products that benefit the public. A CRADA is the only NIH mechanism by which a collaborator can be granted future intellectual property rights in advance of the intellectual property's creation. Under a CRADA, the collaborator has the option to elect an exclusive, a partially exclusive or a nonexclusive license to any government invention(s) made under the CRADA.

### Formation Of Platform JV (FIG. 1)

Functional genomics, high throughput screening, and combinatorial chemistry technologies will be accessed through a joint venture formed with two to three appropriate platform technology companies (PlatformJV). Some companies can perform multiple parts of the Phase B studies, whereas others specialize only in a single technology, such as ADME.

### Phase C—Outlicense

In Phase C, the method involves outlicensing each individual product opportunity to pharmaceutical companies interested in establishing a pipeline of new patented pharmaceutical products that address large, unmet medical needs and have the potential for large profit margins. URAF will derive patent cost fees, development license fees, milestone fees, and royalties on products through these licenses. The structure of such deals is relatively straightforward. Beyond any upfront payments, if the product licensed by the pharmaceutical company is a success, royalties and clinical milestones are usually within standard industry ranges for the status of the product's development, its potential annual sales (allowing for current and future competition), and the time remaining until patent expiration or the end of market exclusivity.

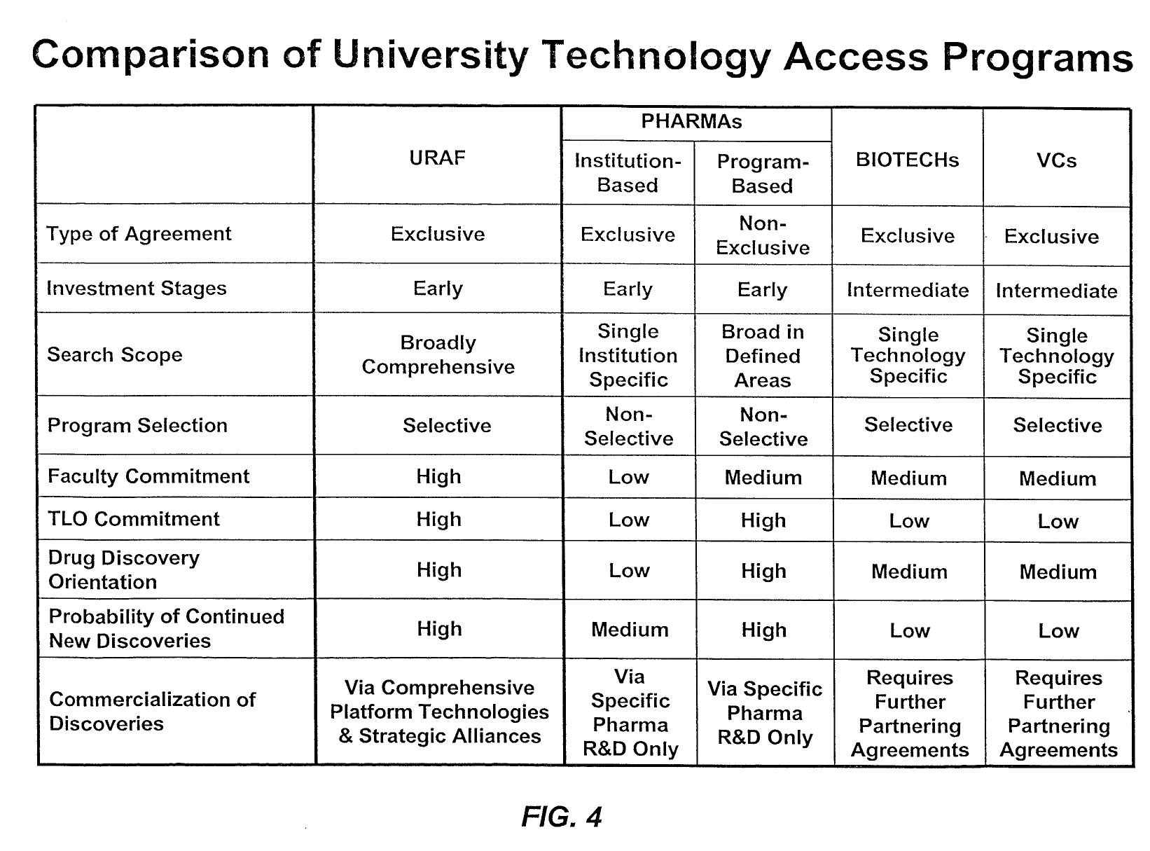

For a summary comparing the method of the invention with other technology access programs please see FIG. 4.

On this basis, the instant invention should be recognized as constituting progress in science and the useful arts, as solving the problems in cardiology enumerated above. In the foregoing description, certain terms have been used for brevity, clearness and understanding, but no unnecessary limitation are to be implied therefrom beyond the requirements of the prior art, because such words are used for descriptive purposes herein and are intended to be broadly construed.

Having described preferred embodiments of the invention with reference to the accompanying drawings, it is to be understood that the invention is not limited to those precise embodiments, and that the various changes and modifications may be effected therein by one skilled in the art without departing from the scope or spirit of the invention s defined in the appended claims. For example, the product can have other shapes, or could make use of other metals and plastics. Thus, the scope of the invention should be determined by the appended claims and their legal equivalents, rather than by the examples given. All changes that come within the meaning and range of equivalency of the claims are to be embraced within their scope.

### Definitions

Unless defined otherwise, all technical and scientific terms used herein have the same meaning as is commonly understood by one of skill in the art to which this invention belongs. All patents and publications referred to herein are incorporated in their entirety by reference.

What is claimed is:

1. A method for accessing an academic research technology comprising the steps of:
Collection of Information on academic research programs;
Organization of said research programs in a bioinformatics capability;
Forming a scientific expert review group;
Evaluating and classifying said research programs with said group;
Obtaining funding;
Funding at least one said research program;
Commercializing results of said one research program through a drug development joint venture; and
Licensing said commerciaized results for profit, whereby said academic research is commercialized.
